(19) United States
(12) Patent Application Publication
(10) Pub. No.: US 2005/0180900 A1
(43) Pub. Date: Aug. 18, 2005

(54) Device for removing oxygen from beverage containers

(75) Inventor: Jens H Popplau, Hamburg (DE)

Correspondence Address: RANKIN, HILL, PORTER & CLARK LLP, 4080 ERIE STREET, WILLOUGHBY, OH, 44094-7836, US

(73) Assignee: ALPLAS GMBH, Hamburg (DE)

(21) Appl. No.: 10/513,937

(22) PCT Filed: May 8, 2003
(86) PCT No.: PCT/EP03/04818

(30) Foreign Application Priority Data
May 10, 2002 (DE) 102 20 695.3

(51) Int. Cl. B01J 19/08

(52) U.S. Cl. 422/186.04

(57) ABSTRACT

A device which removes O₂ from air-filled containers (1) before the container is filled with a beverage and which includes an element (2) loading the container (1) with a material which is oxidizable into an oxidation product that is safe regarding foodstuffs.

### BACKGROUND OF THE INVENTION

The present invention relates to a device for removing oxygen from beverage containers.

Such beverages as beer, lemonades and the like are degraded by oxidation due to oxygen (O₂) contained in the beverage. This condition changes the taste. Accordingly a low proportion of O₂ must be assured when filling the containers with beverage. Another important criterion when filling said containers with beverage is sterility. Biological germs must be precluded from penetrating the beverage wherein otherwise they would multiply, in particular in beverages not enriched with carbon dioxide and also those with high sugar contents, for instance iced tea. Moreover germs substantially restrict the beverage's keeping properties.

Even when beverages are prepared very carefully, that is when they are free both of O₂ and of germs while being filled with said beverages, the ambient air already in the container nevertheless shall enrich them with O₂. Devices of the species of the present invention prevent oxygen enrichment during container filling by removing the O₂ from the air-filled containers.

A number of different devices are known in the state of the art. Prior to the filling procedure, the oxygen may be removed from the container by setting up a vacuum in it, or by flushing the container with an inert gas such as CO₂. It is also known to fill the container in an enclosing chamber with inert gas. However all devices of this kind entail considerable equipment and solve the problem of germ contamination only by using elaborate sterilizing systems that illustratively operate by means of electrically induced plasmas.

The object of the present invention is to create a device of the above cited kind which offers both a simpler design and long-term beverage keeping.

### BRIEF SUMMARY OF THE INVENTION

In the present invention, the container's inside space is loaded with an oxidizable material. By oxidation said oxidizable material consumes the oxygen that is present in the container. In this manner said oxygen is removed in a simple way. This oxidation being an exothermal process, heat is generated that kills the germs that are present. Making use of a simple element, which minimally shall be merely a tube to introduce for instance hydrogen, the two essential procedures of oxygen removal and sterilization required to attain long-keeping beverages are then feasible simultaneously. When loading the container with an oxidizable gas or dust (for instance carbonl dust), uniform and practically automatic distribution in the container's inside volume by swirling can be attained, as a result of which the container's volume is processed uniformly and in its entirety.

The material may be highly reactive, that is self-igniting. Highly reactive dusts such as fine carbon dust may be used. The ignition unit moreover also allows use of materials that are not self-igniting and instead ignition may be controlled to occur at an appropriate operational time. In this manner the design introduces a degree of freedom for operation. An arcing path may be configured within the container to operate in the manner of an automotive spark plug.

At least when the oxidizing procedure proceeds at an appropriate rate, a chemical flame will be generated within the bottle and shall form a plasma. The energy content of said flame may be insufficient to kill all the germs. Thereby the plasma is electrically post-heated to increase the thermal energy. Moreover the plasma shape may be controlled by applying a current to the chemically produced plasma, and as a result and in an illustrative manner the plasma may be guided in a controlled manner to be near the container's inside walls to sterilize them.

Advantageously, energy may be pumped from hf-loaded electrodes into the plasma, for instance this plasma may be shaped as desired.

Alternatively, a heating current from high-voltage loaded point electrodes may be made to pass through the plasma.

When using high-voltage point electrodes, they may be operated at voltages sufficient for ignition and consequently a separate ignition means is unnecessary.

The oxidizing material may be added in small or large amounts. After completion of the reaction, there still would remain residues of oxygen or material. When the material is added stoichiometrically to the O₂ present in the container, the reaction will be residue-free and only the reaction product, for instance water, which is safe—for the foodstuffremains.

The appropriate oxidizing material illustratively may be in the form of dusts, in particular carbon dust, which oxidizes into CO₂. CO₂ is contained anyhow in most beverages and is therefore harmless. H₂ and O₂ result in the end product H₂O. Furthermore the resulting oxyhydrogen reaction is high in energy and very appropriate to kill germs and very suitable to the constitution of a plasma which may be heated electrically.

CO may be used alternatively and be oxidized into CO₂. CH₄ (methane) may be used alternatively, reacting into CO₂ and water and being available very economically. Higher hydrocarbons also may be used for such purposes.

In a further implementation, an oxidizable material may be used which results in an oxidation product suitable as a wall coating. SiH₄ (silane) is suitable for such purposes, being easily distributed in its gaseous form in the container and reacting into SiO₂ which is a material extremely well suited to coating the inside walls of plastic bottles which thereby are imparted higher hermeticity. Also other liquid substances conventionally used in the manufacture of plastic beverage containers to form hermetic layers such as Hexamethyldisiloxane (HMDSO), Tetraethoxysilane (TEOS), Tetramethoxysilane (TMOS) may be used in atomized form for those purposes. Plastic bottles treated in such manner keep longer the carbon dioxide gas contained in beer and lemonades and they block oxygen penetration.

A similar effect may be attained by adding an auxiliary material reacting to a wall coating material. The auxiliary material may be in the form of monomers which during the oxidation of the oxidizable material react into polymers such as polystyrene. The resulting polymers deposit on the container's inside wall and again impart an increase in hermeticity to said container.

The device of the invention should make sure that the invention's removal of oxygen and the sterilization of the inside space of the container being filled is not reversed by contaminating fresh air from the outside. If the device of the present invention operates within a chamber filled with inert gas, any subsequent container contamination shall be precluded.

When the container inside is flushed with an inert gas before the oxidizable material is added, the container's content of oxygen shall already be decreased on that account. Therefore only a lesser quantity of oxidizable material need then be added and the energy of chemical reaction taking place is lowered. In this way the consumption of oxidizable material may be reduced and hence also the heat generated during the chemical reaction. In this manner an additional degree of freedom of control is attained in the procedure being carried out.

The appended drawings show the invention in illustrative and schematic manner.

### BRIEF DESCRIPTION OF THE SEVERAL VIEWS OF THE DRAWINGS

FIG. 1 shows a cross-section of a device according to the invention and of a container, and

FIG. 2 shows an embodiment variation in a view according to FIG. 1.

### DETAILED DESCRIPTION OF THE INVENTION

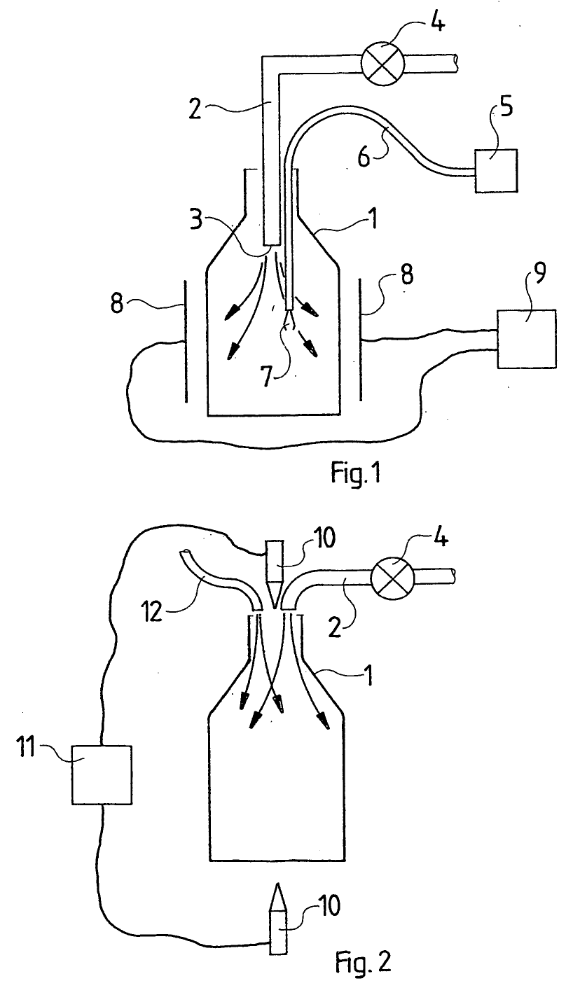

FIG. 1 shows a container 1 mounted by omitted fasteners to the processing site of the device of the invention. Illustratively the container is a presently conventional PET plastic bottle.

The shown device includes a loading tube 2 of which the mouth 3 blows into the inside of the bottle 1. A material from an omitted supply can be blown through the loading tube 2 controlled by a valve 4 in the direction of the arrows into the bottle 1.

Appropriate materials must be oxidizable into an oxidation product safe with respect to foodstuffs. Appropriate materials illustratively are dusts, in particular fine carbon dust that oxidizes to CO₂ which is innocuous for beverages. A number of gases, in particular H₂ (hydrogen), CO (carbon monoxide) and CH₄ (methane) are appropriate materials, which respectively oxidize into water, CO₂, and water and CO₂, that is, being wholly compatible with beverages. Furthermore oxidizable liquids in atomized form also may be used.

In the shown device of the invention, the container 1 is open and filled with air. Accordingly it contains a proportion of O₂ (oxygen). A reactive mixture is created when the said material is blown into the container, and the blowing action assures good mixing throughout the inside volume of the bottle 1.

The oxidation reaction, for instance in the case of the oxohydrogen reaction (O₂ with H₂), is ignitable. For that purpose the device shown in FIG. 1 comprises an ignition system whereby an igniter 5 generating a high-voltage pulse applies, through an ignition cable 6, an ignition voltage pulse to two electrodes 7 configured within the bottle 1. Using appropriate igniter control, ignition may be predetermined at an appropriate processing time.

During the oxidation reaction, the oxygen contained in bottle 1 is consumed. In this procedure, the valve 4 in the loading tube 2 can be controlled in a manner to add the material in an amount which corresponds to the stoichiometric ratio to the oxygen in bottle 1. In that case both the said material and the oxygen shall have been consumed each without leaving a residue.

The exothermal reaction of oxidation for example in the case of the oxohydrogen reaction entails both very high heating of the gas in the bottle and plasma formation. As a result the biological germs contained in the bottle will be killed. If the chemical energy should be insufficient to kill all the germs, then, as shown in FIG. 1, the said plasma may be post-heated electrically.

For that purpose electrodes 8 are mounted on both sides of the bottle 1 and are connected by the shown conductors to the high-frequency generator 9. If said generator is ON during the said oxidation reaction, the high-frequency energy will be pumped into the plasma which is then heated electrically to add to the chemical heat of reaction. However, in an alternative implementation, the applied high-frequency field also may be used instead for heating, for instance to shape the chemically produced plasma in the container, in order to direct the plasma for instance onto the container walls to sterilize this zone.

FIG. 2 shows an embodiment variation making use as far as possible of the same reference numerals as in FIG. 1.

The device shown in FIG. 2 again loads the bottle 1 through the loading tube 2 with an oxidizable material. However point electrodes 10 are configured above and below the bottle and are connected by the shown conductors to a high-voltage generator 11. Said generator is able to generate, at a very high voltage, a disruptive breakdown igniting the reaction, for instance the oxohydrogen reaction. Furthermore the said generator 11 may be used to apply electrical energy in the form of a current between the point electrodes 10 to the plasma of the oxidation reaction so as to heat this plasma or control its shape.

As shown by FIG. 2, the loading tube 2 of this embodiment ends above the rim of the container 1. Accordingly the loading tube 2 need not be raised when changing containers. This design also may be used for the embodiment of FIG. 1.

Besides the materials already cited above, namely carbon dust, hydrogen, CO and the like, oxidizable materials also may be used that react into an oxidation product suitable as a coating substance. In particular SiH₄ (silane) may be used, which reacts into SiO₂ and water. Following its formation, SiO₂ deposits on the container's inside wall and increases its hermeticity. Therefore the filled-up beverage is better protected against penetration by oxygen and against CO₂ leaking. Such goals also may be correspondingly attained using other appropriate materials, for instance the liquids HMDSO, TEOS or TMOS, that may be added in atomized form.

To attain the same goal, an auxiliary material illustratively fed through a second loading tube 12 shown in FIG. 2 may be added to the already cited oxidizable materials such as H₂ or CO which per se do not react into a wall coating substance. Said auxiliary material illustratively may be a monomer which during the oxidation reacts into a polymer. The polymer again deposits on the inside wall of the container 1 and improves its hermeticity.

The devices 1 of the invention shown in FIGS. 1 and 2 operate with open containers 1. In this configuration, ambient fresh air enriched with oxygen and germs may subsequently flow into said containers. To preclude such a condition, said devices of the invention may be placed within a chamber (not shown) filled with sterile inert gas.

As regards the embodiments shown above and prior to the addition of oxidizable material, the container 1 holds ambient/normal air having an oxygen concentration of about 20% as is the case in the standard atmosphere. Accordingly an oxidizable material must be added in the corresponding stoichiometric proportion and, where called for, following ignition, the oxidation reaction then will take place. In this manner the quantity of oxidizable material predetermined by the natural proportion of oxygen will be consumed and a corresponding quantity of heat will be generated by this exothermal process, said heat leading to a strong rise in temperature. In this procedure a substantial quantity of oxidizable material will be consumed and the resulting heat may damage for instance the container, or cause high explosive pressures.

To control such conditions, one embodiment variation offers a flushing element which first flushes the container 1 with an inert gas such as CO₂. The flushing element may be the loading tube 2 which is connected (not shown) through a switching valve to a supply of inert gas in addition to being connected to the supply of oxidizable material.

Because of the prior flushing of the container, the oxygen proportion in the inner container space will be reduced for instance from 20 to 5%. A relatively short time of flushing suffices for such reduction. Then, after switching the switching valve, oxidizable material is fed through the loading tube 2 in the manner described above and in a quantity matching the stoichiometric ratio relative to the residual oxygen proportion in the container after said initial flushing. As a result the consumption of oxidizable material is reduced and so is the energy generated by the exothermal reaction.

1. A device for removing O₂ from air-filled containers (1) before filling with a beverage comprising:
it comprising an element (2) which uniformly loads the container (1) through its volume with a material which can be oxidized into an oxidation product that is safe regarding the foodstuff.

2. The device of claim 1, comprising an ignition system (7, 10) which effects an ignition within the volume of the container.

3. The device of claim 2, wherein the ignition system comprises an arcing gap (7) arranged within the container (1).

4. The device of claim 1, further comprising a system (8, 10) to apply an electric current to a plasma generated during oxidation.

5. The device of claim 4, further comprising hf-loadable electrodes (8) configured outside the container (1).

6. The device of claim 4, further comprising external, hf-loadable point electrodes (10).

7. The device of claim 3, further comprising a generator (11) producing high voltage adequate for ignition of said material.

8. The device of claim 1, wherein the material is stoichiometrically added to the O₂ contained in said container.

9. The device of claim 1, wherein the material is H₂.

10. The device of claim 1, wherein the material is CO.

11. The device of claim 1, wherein the material is CH₄.

12. The device of claim 1, wherein the material oxidizes into an oxidation product suitable for wall coating.

13. The device of claim 12, wherein the material is SiH₄.

14. The device of claim 1, further including an auxiliary material reacting into a wall coating during the oxidation reaction that is added to the oxidizable material.

15. The device of claim 1, wherein the container (1) is enclosed in a chamber filled with inert gas.

16. The device of claim 1, further comprising a flushing element (2) flushing with inert gas the container (1) prior to said container being loaded with the oxidizable material.

17. The device of claim 6, further comprising a generator (11) producing high voltage adequate for ignition of said material.
